(19) United States
(12) Patent Application Publication
(10) Pub. No.: US 2007/0130937 A1
(43) Pub. Date: Jun. 14, 2007

(54) Hydraulic system for pivoting the lateral structural parts of a truck upwards and downwards

(76) Inventor: Gisela Weber, Gattendorf (AT)

Correspondence Address: SHLESINGER, ARKWRIGHT & GARVEY LLP, 1420 KING STREET, SUITE 600, ALEXANDRIA, VA, 22314, US

(21) Appl. No.: 11/646,580

(22) Filed: Dec. 28, 2006

Related U.S. Application Data
(63) Continuation of application No. PCT/EP05/05425, filed on May 19, 2005.

(30) Foreign Application Priority Data
Jun. 28, 2004 (DE) 10 2004 031 202.8

(51) Int. Cl. F16D 31/02

(52) U.S. Cl. 60/484

(57) ABSTRACT

Hydraulic system for pivoting the lateral structural parts of a truck upwards and downwards. Hydraulic system includes a hydraulic control unit provided with a hydraulic pump and hydraulic valves; a first hydraulic cylinder and a second hydraulic cylinder for pivoting a first component; and a third hydraulic cylinder and a fourth hydraulic cylinder for pivoting a second component. The hydraulic cylinders are embodied in a single-acting manner with an oil chamber and a spring counteraction. A check valve is provided between the at least one external hydraulic line and the oil chambers, the check valve blocking or enabling a reflux of the hydraulic liquid from the oil chamber into an external hydraulic line. In regulated positions of the lateral structural parts and when the hydraulic pump is not actuated, the check valve blocks backflow of the hydraulic liquid from the oil chamber and the external hydraulic line is depressurized.

### CROSS-REFERENCE TO RELATED APPLICATIONS

This application is a continuation of application no. PCT/EP2005/005425, filed May 19, 2005, which claims the priority of German application no. 10 2004 031 202.8, filed 28 Jun. 2004, and each of which is incorporated herein by reference.

The invention relates to a hydraulic system for pivoting wing components of a truck upward and downward.

### FIELD OF THE INVENTION

Wing components of this type on a truck, also called wing bodies, are pivotably attached to the upper side of the truck superstructure and can be pivoted upward to allow lateral access to the truck's cargo area.

### BACKGROUND OF THE INVENTION

Wing bodies or wing components of a truck are customarily pivoted upward and downward by means of dual-action hydraulic pistons. To accomplish this, a control unit is provided, for example on the truck's underbody, with a hydraulic pump that is actuated via a motor and itself controls eight external hydraulic lines, namely one hydraulic line for each of the two chambers of each of the four hydraulic cylinders, via two parallel connected 4/3-way valves and coordinating check valves. Once the respective wing component has been pivoted, the check valve is placed in a blocking setting, so that the pressure established in the external hydraulic lines is blocked and the wing component remains in its respective position.

However, significant safety issues can occur with this arrangement. If the truck is parked at a low temperature—for example early in the morning after a first drive—with the pressure established in the cylinders and the external hydraulic lines, and then a general warming of the vehicle's superstructure and the hydraulic lines occurs, for example by the sun's rays, this results in a significant increase in pressure in the hydraulic volume that is isolated in the external hydraulic lines, for example a 10 bar difference in pressure at a temperature difference of 1° C., so that at temperature differences of 10° C., pressure increases of 100 bar or more can occur. In addition, an uneven pressure increase will occur in the hydraulic lines, as the respective piston rod is directed through one of the two oil chambers of each dual-action hydraulic cylinder, and thus the relevant oil chamber pressurizes the piston over a smaller cross-sectional surface than the other oil chamber. A general pressure increase in the hydraulic system will thus lead to an uneven action of force on the pistons, so that with an equalization of force via the pistons, the pressure in one oil chamber and the connected hydraulic line can be further increased.

In such cases hydraulic lines can crack, which can lead to substantial damage and also to a sudden drop of the respective wing component, thus endangering persons and objects. Furthermore, oil can escape from the cracked hydraulic lines, which can lead to a contamination of the goods in the cargo area.

### OBJECTS AND SUMMARY OF THE INVENTION

The object of the invention is to create a hydraulic system that can be cost-effectively implemented and will ensure a high level of safety.

This object is attained with a hydraulic system including a hydraulic control unit with a hydraulic pump and hydraulic valves. A first, forward hydraulic cylinder and a second, rear hydraulic cylinder for pivoting a first wing component of a truck. There is a third, forward hydraulic cylinder and a fourth, rear hydraulic cylinder for pivoting a second wing component of a truck, and the hydraulic cylinders each are configured to be single-acting, with an oil chamber and a spring counteraction, and adjustable by the control unit via at least one external hydraulic line. A check valve is provided between the at least one external hydraulic line and the oil chambers of the hydraulic cylinders, and the check valve is configured for blocking and enabling a backflow of the hydraulic fluid from the oil chamber to the at least one external hydraulic line. The check valve being configured so that, in a stationary position, with adjusted positions of the wing components and a non-actuated hydraulic pump, the check valve blocks the backflow of hydraulic fluid from the oil chamber, and the at least one external hydraulic line is pressureless, in use.

The invention likewise includes that the check valves are integrated into the hydraulic cylinders.

Further, the hydraulic system includes that the check valves are 2/2-way valves, each with at least one electromagnetic actuation.

The hydraulic further includes that the check valves include one position in which they block in both directions and one position in which they release in both directions, or include one position in which they block backflow from the oil chamber on one side and one position in which they enable backflow from the oil chamber.

Additional embodiments are set forth below.

According to the invention, the hydraulic cylinders are thus structured to be single-acting or to include a spring return. The spring return stroke can advantageously be effected with a pneumatic spring that is integrated into the cylinder; however a cylinder spring may also be provided, for example.

According to the invention, check valves are positioned in front of (i.e., upstream) from the hydraulic cylinders and block the pressure that is established in the respective oil chamber in relation to the external hydraulic lines. They can, in particular, be integrated into the cylinders or their housings, so that no additional lines are required between the check valves and the oil chambers, and therefore a cost-effective implementation with a high level of safety is possible.

According to the invention, one, two or four external hydraulic lines can be provided, whereby in the case of one or two hydraulic lines, junctions to the check valves are provided near the respective hydraulic cylinders. Thus, the overall length of the external hydraulic lines can be significantly decreased, to approximately one-fourth of the overall length of conventional systems. Because, especially in the case of wing components, the forward hydraulic cylinder and the rear hydraulic cylinder lie close to one another, the overall length of the external hydraulic lines is determined by the hydraulic lines leading out of the control unit, and, to only a minor degree, by the hydraulic lines that branch off.

To lower the wing components, the oil chambers for the hydraulic cylinders can be connected to the hydraulic system outlet in the hydraulic reservoirs via shuttle valves, without actuating the motor and with bridging or bypassing of the pump. The check valves can be especially 2/2-way valves having either a normal position that blocks on both sides and an engaged position that releases on both sides, or a normal position that functions as a check valve, blocking the outflow of oil on one side and an engaged position that enables the outflow of oil. Depending upon the construction of the check valves, they can be actuated with the control signal that is also used to actuate the motor, with a reset signal that differs from it.

Below, the invention will be described in greater detail with reference to the attached set of diagrams depicting a number of embodiments.

### BRIEF DESCRIPTION OF THE DRAWINGS

FIG. 1 is a perspective view of a truck according to the invention, with hydraulically adjustable wing components;

FIG. 2 is a circuit diagram of a hydraulic system according to the invention for adjusting the wing components according to a first embodiment, with an external hydraulic line leading out of the control unit;

FIG. 3 is a hydraulic system according to the invention for actuating the wing components according to a further embodiment, with two hydraulic lines leading out of the control unit and with a reversible pump;

FIG. 4 is a circuit diagram of a hydraulic system according to the invention for adjusting the wing components according to an additional embodiment, with two hydraulic lines leading out of the control unit;

FIG. 5a is a front view and FIG. 5b is a plan view of a wing component of FIG. 1 in I an upward pivoted position and II a downward pivoted position;

FIG. 6a is an axial section of an embodiment according to the invention of the single-acting hydraulic cylinder for adjusting the wing component, with an integrated check valve;

FIG. 6b is the radial section A-A from FIG. 6a; and

FIG. 6c is the circuit diagram of the hydraulic cylinder from FIG. 6a, b.

### DETAILED DESCRIPTION OF THE INVENTION

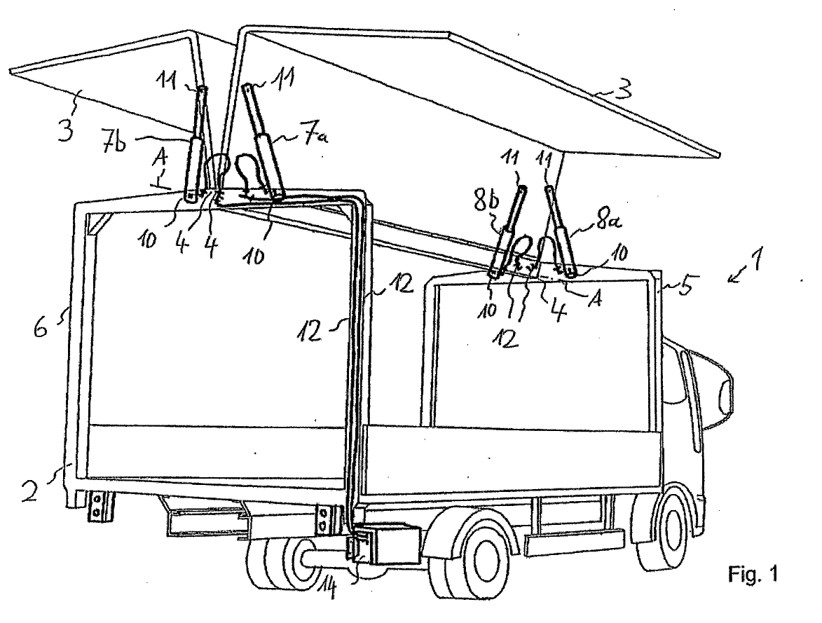

A truck 1 has a superstructure 2 and two wing components 3, which are mounted on the superstructure 2 in two parallel pivot axes A that extend in the longitudinal direction of the vehicle. The wing components 3 or wing bodies are constructed such that their cross-sections form right angles, so that when pivoted down they enclose the cargo area of the truck 1 on three sides, and in the upward pivoted or extended position shown in FIG. 1 they allow lateral access to the cargo area. The two pivot axes A of the two wing components 3 are accordingly positioned relatively close to one another at the center area of the truck 1, with bearings 4 in a front frame section 5 and a rear frame section 6 of the superstructure 2.

The wing components 3 are each pivoted via a rear hydraulic cylinder 7a or 7b, respectively, and a front hydraulic cylinder 8a and 8b, respectively, which are hinged at bearing points 10 on the superstructure and at bearing points 11 on the wings. The hydraulic cylinders 7a, b, 8a, b are single-acting and are connected to a hydraulic control unit 14 via a hydraulic line 12, via two hydraulic lines 12a, b, or via hydraulic lines 13 that branch off of the hydraulic line or lines at junctions 92, 93, 97, wherein the control unit is arranged, for example, on the underbody of the superstructure 2 of the truck 1. In the respective hydraulic cylinders 7a, b and 8a, b, check valves are installed or integrated, as will be detailed below in reference to the hydraulic wiring diagrams or circuit diagrams.

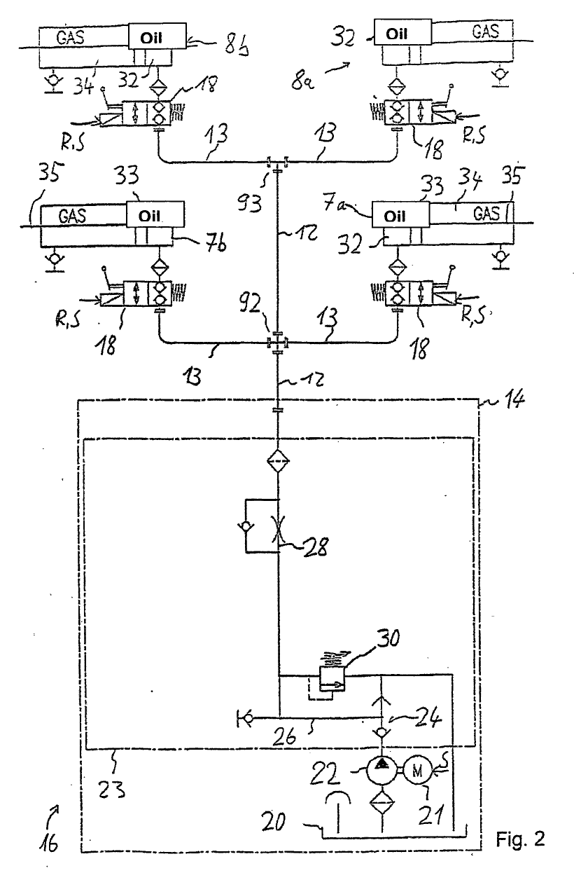

FIG. 2 through 6 depict various embodiments of the hydraulic system 16 of the invention, each of which includes a control unit, hydraulic lines 12, 12a, b, 13 and hydraulic cylinders 7a, b and 8a, b, with integrated electrical check valves 18.

The control unit 14 of the embodiment shown in FIG. 2 includes a hydraulic reservoir 20, a hydraulic pump 22 actuated via a motor 21, and a hydraulic control unit 23 that is connected to the hydraulic pump 22. The control unit 23 includes a shuttle valve 24 that is connected to the pump 22, which shifts from the closed or blocked normal position shown here to an opened position when pressurized by the pumping process of the hydraulic pump 22, thus opening up a hydraulic line 26, which leads via a flow-control valve 28 to the outlet of the hydraulic control unit 23, which is connected, via a coupling of the control unit 14, to the one external hydraulic line 12 that is positioned on the truck 1, which is in turn connected via junctions 92, 93 to further hydraulic lines 13. In the closed or blocked position shown here, a backflow from the flow-control valve 28 to the hydraulic reservoir 20 via the shuttle valve 24 is enabled. Additionally, a safety valve 30 is installed between the flow-control valve 28 and the hydraulic reservoir 20, and thus bridges the shuttle valve 24 and the hydraulic pump 22 in the event of an overpressure in the hydraulic line 26 when the shuttle valve 24 is engaged.

The electrical check valves 18 are structured as dual-action 2/2-way valves, which, in the normal position of the hydraulic system 16 shown in FIG. 2, are blocked on both sides, and are switched to their opened position when a corresponding electrical control signal S is received, which also actuates the motor 21. In this embodiment, the hydraulic cylinders 7a, b and 8a, b are structured as single-acting, pneumatically spring-mounted or pneumatically mounted hydraulic cylinders. Thus in each case the electrical check valve 18 actuates only one oil chamber 32, which forces the piston 33 against a closed pneumatic chamber 34 that acts as a pneumatic spring, through which the piston rod 35 extends. The check valves 18 can advantageously also be manually actuated, for example via a lever as shown in the figures.

In the normal position or idle position of the hydraulic system 16 shown in FIG. 2, the motor 21 is switched off, wherein the electrical check valves 18 separate the oil chambers 32 of the hydraulic cylinders 7a, b and 8a, b from the hydraulic line 12. The internal hydraulic line 26 of the control unit 23 and the external hydraulic line 12, which extend on the truck 1 or its superstructure 2, are thus pressureless. If the pressure in the hydraulic lines 12 increases, for example as a result of an increase in temperature when the truck 1 is parked when the temperature is cold and is then significantly warmed, for example by intense sunshine, this increase in pressure is not passed on via the blocked check valves 18 to the hydraulic cylinders 7a, b and 8a, b, and is instead released via the shuttle valve 24 to the hydraulic reservoir 20.

To pivot the wing components 2 upward, the driver or operator activates a switch, which transmits control signals S, directly or via a control device that is part of the truck 1, both to the motor 21 and to the relevant electrical check valves 18, for example two or four electrical check valves 18. This causes the motor 21 to actuate the pump 22, so that the external hydraulic line 12 is pressurized, and the respective oil chambers 32 are pressurized via the opened check valves 18 causing them to displace the pistons 33. Once the wing components 3 are in the open position shown in FIG. 1, the motor 21 is switched off again and the check valves 18 are switched back to their normal position, so that only the pistons 33 are shifted from their position shown in FIG. 2. Thus when the wing components 3 are in an upwardly pivoted or extended position, the external hydraulic line 12 and the internal hydraulic line 26 are also pressureless. To pivot the wing components 3 downward, a control signal S can again be sent to the check valves 18—without actuation of the motor 21—which will open them, so that the single-acting hydraulic cylinders 7a, b and 8a, b, due to the spring effect of the pneumatic spring 34 and supplementarily due to the weight of the wing components 3, are reset and the hydraulic fluid is released from the oil chambers 32 via the opened check valves 18, the external hydraulic line 12, and the shuttle valve 24 into the hydraulic reservoir 20. In this manner, a soft, damped closure of the wing components 3 is achieved by use of the flow-control valve 28.

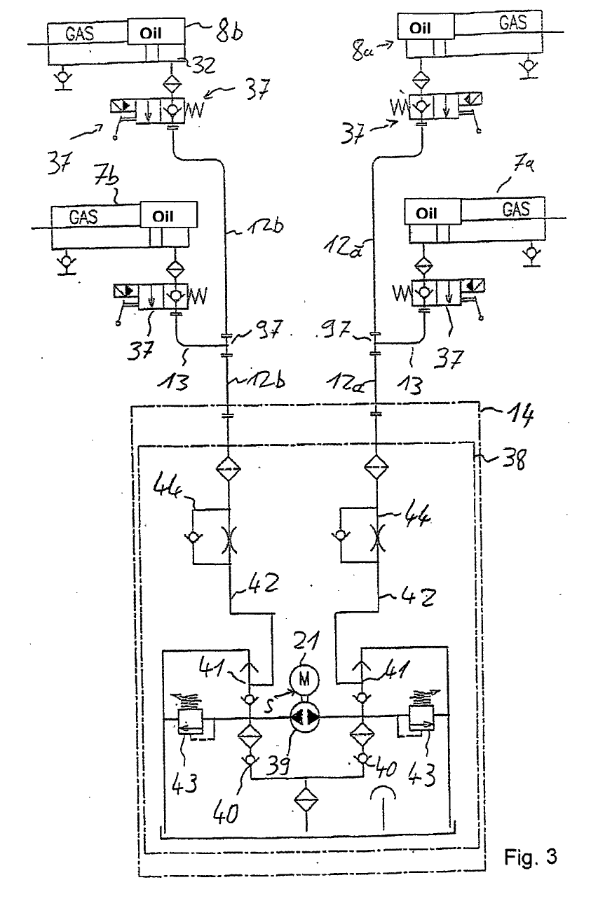

In the embodiment shown in FIG. 3, two external hydraulic lines 12a, b are connected to the hydraulic control unit 14. The electrical check valves 37 upstream from each hydraulic cylinder 7a, b, 8a, b are also structured as 2/2-way valves, however—as an alternative to FIG. 2—in the normal position or idle position shown here they block on one side, so that as check valves they prevent a backflow of the hydraulic fluid from the oil chamber 32, and in the engaged position they permit only a backflow from the oil chamber 32 into the hydraulic lines 12.

Further, in the hydraulic control unit 14 a reversible hydraulic pump 39 is actuated by the motor 21, wherein two branches that are symmetrical to one another lead out of the pump, each being secured in relation to the hydraulic reservoir 20 via safety valves 43 and supplementarily via check valves 40, so that the occurrence both of an excess overpressure and of an insufficient pressure at the outlets of the hydraulic pump 39 are prevented. In both branches, shuttle valves 41 are connected to the hydraulic pump 39, which correspond to the above-described shuttle valves 24 from FIG. 2 and open to a common internal hydraulic line 42 with actuation of the pump.

Two flow-control valves 44 are parallel-connected to the internal hydraulic line 42, wherein the two right hydraulic cylinders 7a and 8a as a group and the two left hydraulic cylinders 7b and 8b as a group are connected via one hydraulic check valve 37 each to the flow-control valves 44 via two external hydraulic lines 12a, b, respectively, and, if applicable, via a junction 97 and a hydraulic line 13.

The circuit connections in the embodiment shown in FIG. 3 are essentially the same as those of FIG. 2. In the normal position shown here, when the wing components 3 are closed, the check valves 37 are closed and the external hydraulic lines 12 are pressureless and are directly connected to the hydraulic reservoir 20 via the shuttle valves 41. To pivot the wing components 3 upward, the motor 21 [sic] is again switched on via a control signal S; however, in contrast to FIG. 2, the check valves 37 are not engaged. The adjustment process is ended by switching off the motor 21, wherein the pressure in the oil chamber 32 is retained by the check valves 37. The pressure that is stored in the external hydraulic lines 12a, b, 13 and the internal hydraulic line 42 can be released directly into the hydraulic reservoir 20 when the motor 21 is switched off. To lower the wing components 3, reset signals R can be transmitted to the check valves 37, which open them, thereby enabling the direct backflow into the hydraulic reservoir 20 via the flow-control valves 44 and the shuttle valves 41. Alternatively, the check valves 37 can also be manually actuated.

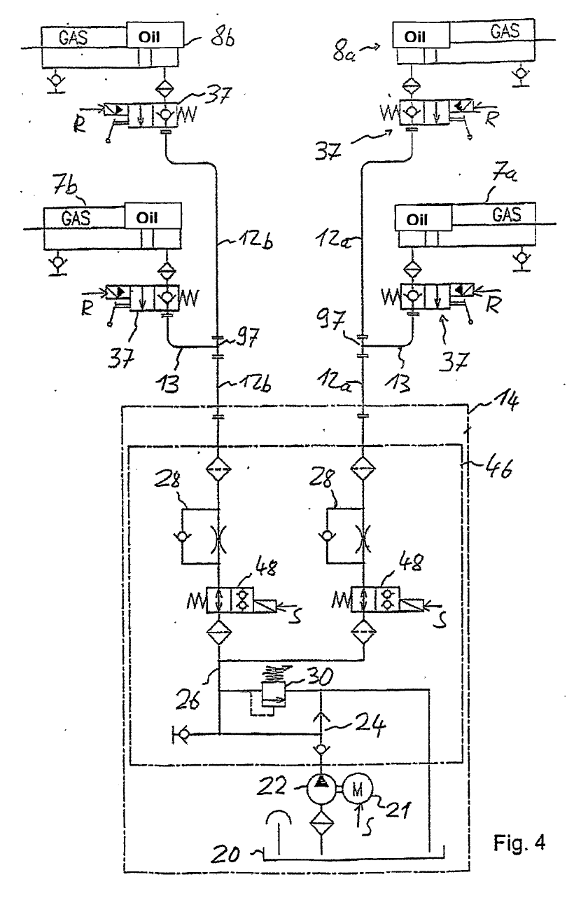

In the embodiment of FIG. 4, the control unit 14 is structured essentially to correspond to that of FIG. 2, wherein a hydraulic control unit 46 is connected to the motor 21 and the pump 22, which control unit—unlike that of FIG. 2—includes two parallel-connected flow-control valves 28 in the internal hydraulic line 26, wherein the valves are each connected to the internal hydraulic line 26 via an electrically or electromagnetically actuated control valve 48, which is structured as a 2/2-way valve with a normal position that is open on both sides and an engaged position that blocks on both sides. With the control valves 48, therefore, the left and/or right external hydraulic line 12a, 12b can be optionally pressurized, thereby actuating the cylinders 7a, 8a or the cylinders 7b, 8b, or all the cylinders 7a, b, 8a, b, with a pump process.

In principle it is also possible, as an alternative to the embodiments depicted here, for a dedicated external hydraulic line to extend from the control unit to each cylinder, however this is more costly as it requires a significantly greater overall length of hydraulic lines.

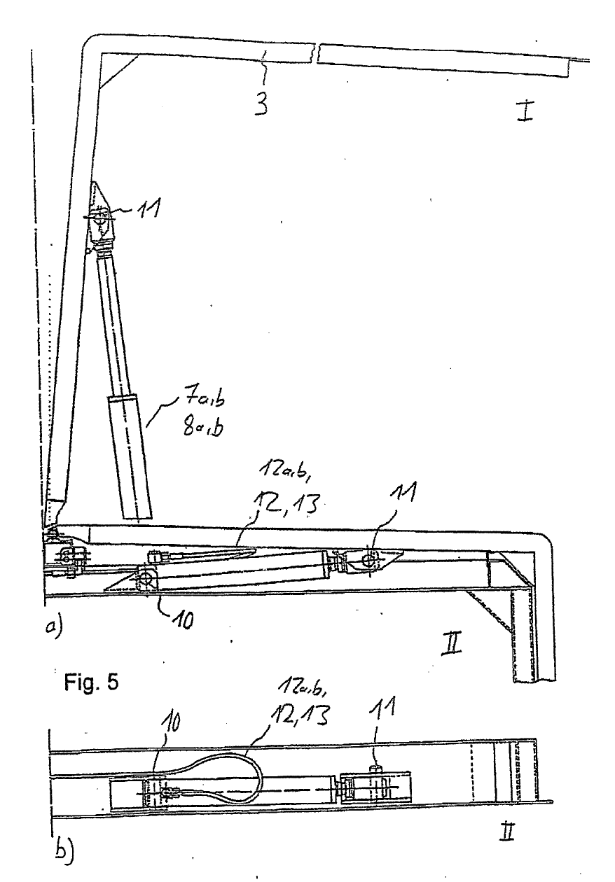

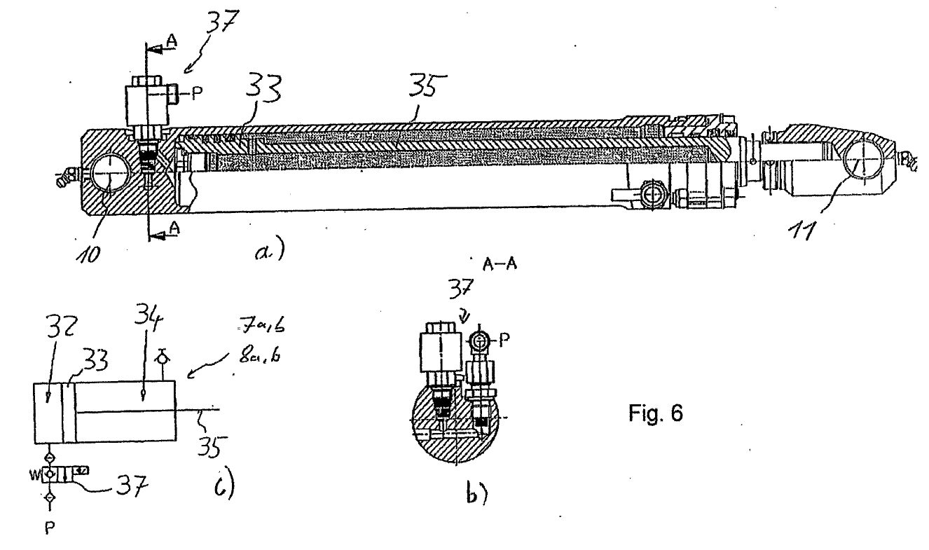

FIG. 5 shows the wing component 3 in the upward-pivoted position I and the downward pivoted position II, wherein this arrangement applies to all single-acting hydraulic cylinders 7a, 7b and 8a, b in this or in a mirror arrangement. The check valves 18 can be integrated into the hydraulic cylinders 7a, b and 8a, b and into the corresponding hydraulic cylinders of additional embodiments, corresponding to FIG. 6.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Hydraulic system for pivoting wing components of a truck upward and downward, comprising:
a) a hydraulic control unit with a hydraulic pump and hydraulic valves;
b) a first, forward hydraulic cylinder and a second, rear hydraulic cylinder for pivoting a first wing component of a truck;
c) a third, forward hydraulic cylinder and a fourth, rear hydraulic cylinder for pivoting a second wing component of a truck;
d) the hydraulic cylinders each being configured to be single-acting, with an oil chamber and a spring counteraction, and adjustable by the control unit via at least one external hydraulic line;
e) a check valve being provided between the at least one external hydraulic line and each of the oil chambers of the hydraulic cylinders, and the check valve being configured for blocking and enabling a backflow of the hydraulic fluid from the oil chamber to the at least one external hydraulic line; and
f) the check valve being configured so that, in a stationary position, with adjusted positions of the wing components and a non-actuated hydraulic pump, the check valve blocks the backflow of hydraulic fluid from the oil chamber, and the at least one external hydraulic line being pressureless.

2. Hydraulic system according to claim 1, wherein:
a) the check valves are integrated into the hydraulic cylinders.

3. Hydraulic system according to claim 1, wherein:
a) the check valves are 2/2-way valves, each with at least one electromagnetic actuation.

4. Hydraulic system according to claim 1, wherein:
a) the check valves include one position in which they block in both directions and one position in which they release in both directions, or include one position in which they block only backflow from the oil chamber and one position in which they enable backflow from the oil chamber.

5. Hydraulic system according to claim 1, wherein:
a) in a stationary position, the at least one external hydraulic line is connected to a hydraulic reservoir of the hydraulic system, bypassing the hydraulic pump.

6. Hydraulic system according to claim 5, wherein:
a) between the hydraulic pump and the at least one external hydraulic line a shuttle valve is provided, which opens with pump operation, and thereby enables a connection between the hydraulic pump and the at least one external hydraulic line, and in the blocking position enables a backflow from the external hydraulic line to a hydraulic reservoir.

7. Hydraulic system according to claim 6, wherein:
a) the hydraulic pump and the shuttle valve are bypassed via a safety valve.

8. Hydraulic system according to claim 1, wherein:
a) a dedicated hydraulic line leads from the control unit to each hydraulic cylinder.

9. Hydraulic system according to claim 1, wherein:
a) only two hydraulic lines lead out of the control unit, each of which is connected directly and via a junction, respectively, to the two check valves of the hydraulic cylinders of one of the two wing components.

10. Hydraulic system according to claim 1, wherein:
a) only one hydraulic line leads out of the control unit and is connected at two junctions, arranged in series, to the check valves of two hydraulic cylinders.

11. Hydraulic system according to claim 1, wherein:
a) the springs in the single-acting hydraulic cylinders are one of pneumatic springs and cylinder springs.

12. Hydraulic system according to claim 1, wherein:
a) the check valves are electromagnetically and manually actuated.
